(19) United States
(12) Patent Application Publication
(10) Pub. No.: US 2016/0239727 A1
(43) Pub. Date: Aug. 18, 2016

(54) Apparatus and Method for Large Area Printing

(71) Applicant: Tungsten IP, Richmond, KY (US)

(72) Inventors: Ronald Trissel, Lakeland, FL (US); John R. Creasy, JR., Barlow, FL (US); David Charles Weatherly, Versailles, KY (US); Frank Edward Anderson, Sadieville, KY (US); Agnes K. Zimmer, Lexington, KY (US); Curtis Ray Droege, Richmond, KY (US)

(73) Assignee: Tungsten IP, Richmond, KY (US)

(21) Appl. No.: 15/043,609

(22) Filed: Feb. 14, 2016

Related U.S. Application Data
(60) Provisional application No. 62/116,478, filed on Feb. 15, 2015.

(51) Int. Cl. G06K 15/02; B41J 3/407; H04N 1/56

(52) U.S. Cl. CPC G06K 15/021; H04N 1/56; G06K 15/1803; B41J 3/407

(57) ABSTRACT

A wide area printer is capable of printing large images on non-typical surfaces such as pavement, grass, or soil. The printer is a wheeled device that is capable of multiple configurations including a plurality of drop nozzle arrays and a plurality of spray nozzle arrays. Each nozzle is independently addressable. Alternately, a group of nozzles may be addressed simultaneously. Each array of nozzles contains a carrier and a colorant. The colorant may be pre-mixed in the carrier, or may be mixed in-situ.

### BACKGROUND

1. Field of the Disclosure

The present disclosure relates to an apparatus and method for printing large areas on surfaces such as turf playing fields, fairways, or pavement. The disclosure is particularly suitable for printing logos or advertisements, or for striping a playing field.

2. Description of the Related Art

Large area images are used for advertising a sporting team's home field. In American football, it is common for the home team to paint a logo in center-field. For example, the NFL logo painted in center-field is about 60 feet wide by about 70 feet high. These are currently painted using stencils and compressed air paint guns, wherein the paint in manually applied. This is a slow process, requiring elaborate equipment simply to create the templates. Then the templates must be laid out and held secure while painting is performed manually. Drying time is required prior to removing one stencil, then another stencil is laid out with reference to the first for a second paint color.

What is needed is a digital method of creating large area images with the efficiency akin to desktop digital printing.

### SUMMARY

The present disclosure provides an apparatus for use in printing large areas by traversing a surface to be printed. Areas larger than the printing width can be achieved by use of optical imaging sensors for sensing previously printed portions of the image and/or by navigation sensors for communicating a position and controlling a printing command.

Another embodiment of the present disclosure provides an apparatus for use in printing large areas by using a combination of spray nozzle arrays and drop nozzle arrays.

Yet another embodiment of the present disclosure provides an apparatus for use in erasing previously printed large area images.

Features and advantages of the present disclosure will be more understood through the detailed description and in reference to the figures which follow.

### BRIEF DESCRIPTION OF THE DRAWINGS

FIG. 1 is a top view of a mobile printing system shown movably printing a large area image about the width of the printer;

FIG. 2a is a top view of a mobile printing system shown movably printing a large area image greater than the width of the printer;

FIG. 2b is a top view of a mobile printing system shown movably printing a large area image greater than the width of the printer;

FIG. 2c is a top view of more than one mobile printing systems shown movably printing a large area image greater than the width of the printer;

FIG. 3a is a side view of a mobile printing system comprised of a transport system and a nozzle array frame system;

FIG. 3b is a rear view of the drop nozzle array frame system from view A-A taken from FIG. 3a;

FIG. 3c is a view of the spray nozzle array as shown from view B-B taken from FIG. 3a;

FIG. 4a is a section view of a mixer for mixing colorant in-situ;

FIG. 4b is a schematic of portion of a fluid system including a mixer;

FIG. 5(a-d) shows a mobile printing system capable of articulating tight turns in a limited area;

FIG. 6(a-b) shows a pictorial view of an exemplary nozzle control valve in two operational states;

FIG. 7a shows a simplified spray nozzle in operation;

FIG. 7b shows a simplified drop nozzle in operation;

FIG. 8 is a logical schematic of a print controller for use in a mobile printing system;

### DETAILED DESCRIPTION

It is to be understood that various omissions and substitutions of equivalents are contemplated as circumstances may suggest or render expedient, but these are intended to cover the application or implementation without departing from the spirit or scope of the claims of the present disclosure. It is to be understood that the present disclosure is not limited in its application to printing large areas set forth in the following description. The present disclosure is capable of other embodiments and of being used in various applications. Also, it is to be understood that the phraseology and terminology used herein is for the purpose of description and should not be regarded as limiting. The use of “including,” “comprising,” or “having” and variations herein is meant to encompass the items listed thereafter and equivalents thereof as well as additional items. Further, the terms “a” and “an” herein do not denote a limitation of quantity, but rather denote the presence of at least one of the referenced item. As used herein, the terms printer, printing device, mobile printer and mobile printing system are intended to be synonymous and interchangeable.

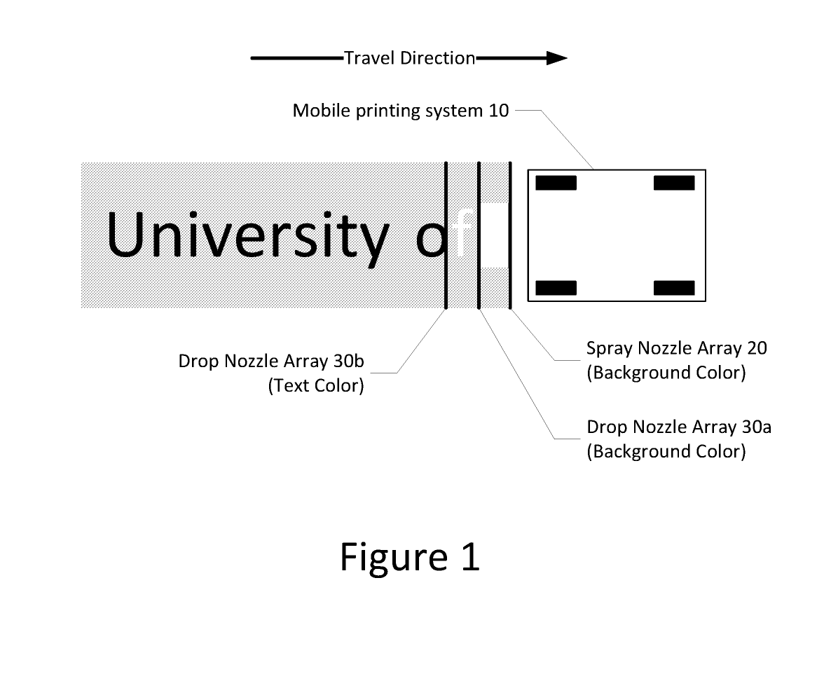

FIG. 1 shows a top view of a mobile printing system 10 shown movably printing a large area image about the width of the mobile printing system 10. The large area image represented here is a partially printed end zone of a football field, therefore the mobile printing system 10 is normally several feet wide, such as four feet, six, feet, or eight feet wide. The principles of this disclosure enable functionality from mobile printing systems as small as one foot wide, to twenty feet wide or more. In the figure, a mobile printing system 10 includes three nozzle arrays. A spray nozzle array 20 is shown printing a large area of a solid color (a background color in this instance). This is followed by a drop nozzle array 30a printing the remainder of the background color. A text color is printed by a second drop nozzle array 30b. The sequence of printing in this example ensures, by first printing with spray nozzle array 20, that the text color is not affected by overspray which may occur with the use of spray nozzle arrays. The set of nozzle arrays is, collectively, a nozzle array group 35. The nozzle array group 35 may be one or more nozzle arrays in any combination of spray nozzle arrays or drop nozzle arrays, and positioned in any order for mobile printing. There may also be more than one nozzle array group 35. In a non-illustrated example, a nozzle array group 35 may be configured at the front of a mobile printing system 10 and another at the back in reverse order. In this example it may be desired to print only with the nozzle array group 35 that is behind the mobile printing system 10 thus enabling printing in forward or reverse directions.

Surface or surfaces, as discussed herein, may be any type of turf, field, fairway, or pavement upon which fluid may be deposited.

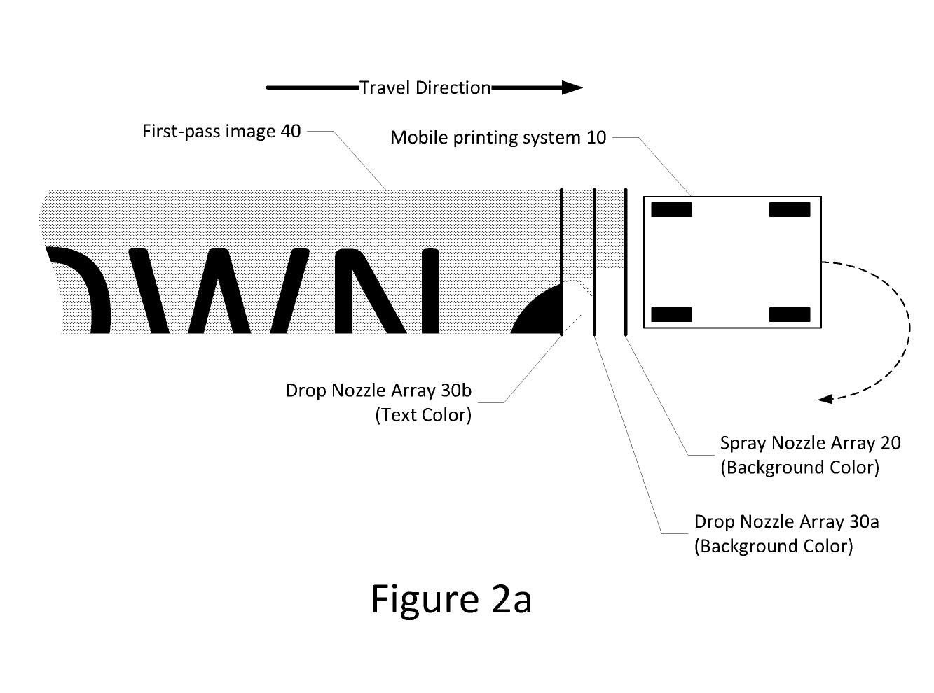

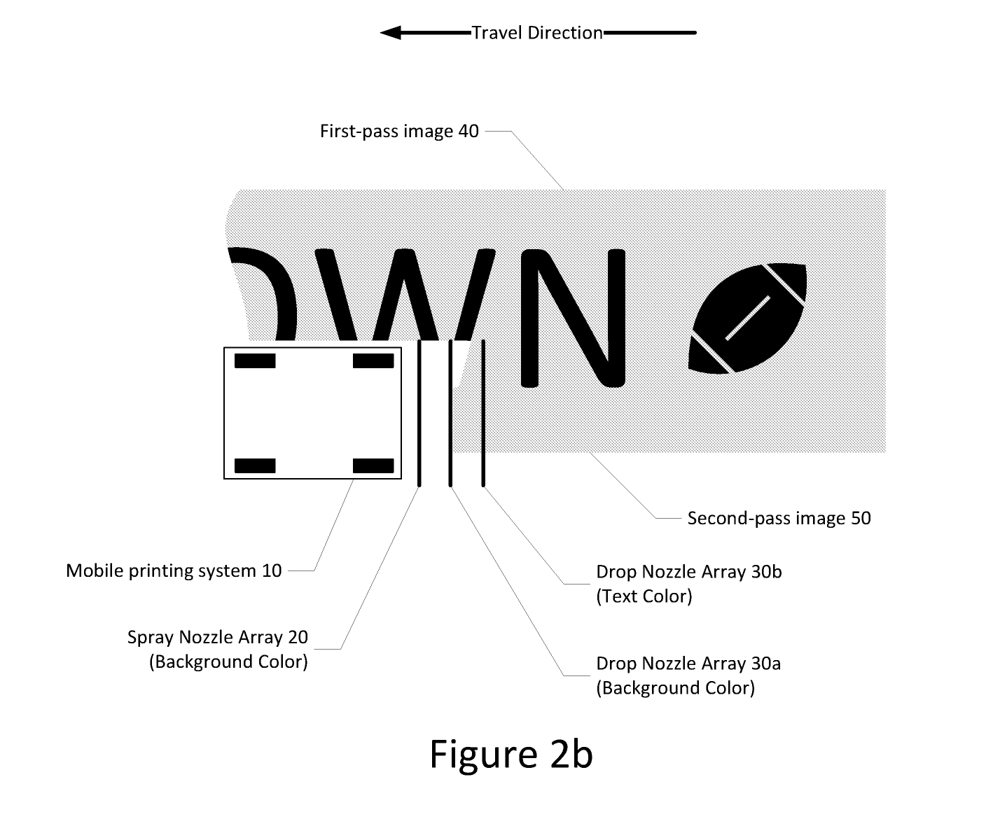

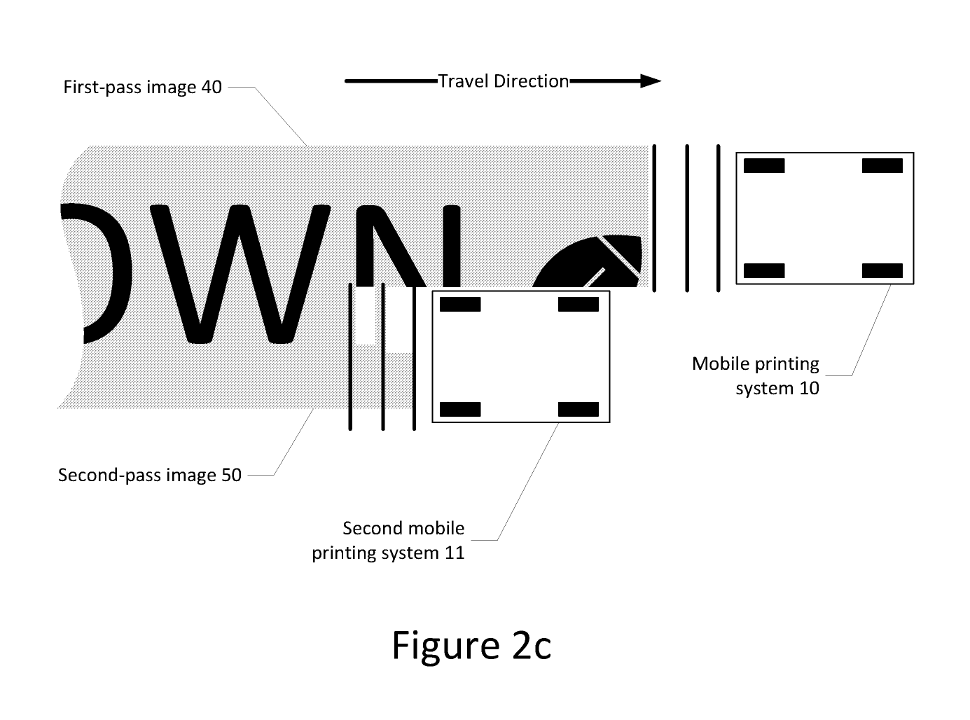

FIG. 2a is a top view of a mobile printing system 10 shown movably printing a large area image greater than the width of the mobile printing system 10. In this example, the mobile printing system 10 is shown wherein the length of a printed image, shown here printing from left to right, is nearly complete. This is a first “swath”, forming a first-pass image 40. An arrow formed as a dashed line shows the first mobile printing system 10 is to make a 180 degree turn, then print the remainder of the image. The remainder of the image will be printed in reverse order, from right to left. A sensor system (not shown in this view) is used to sense the edges of the first-pass image 40, and features in the previously printed image, to register the to-be-printed second-pass image 50 to the first-pass image 40. The sensor system ensures stitching of the image even if the mobile printing system 10 does not traverse an idea path.

FIG. 2b is a top view of the mobile printing system 10 embodiment of FIG. 2a, wherein the second-pass image 50 is nearly complete.

FIG. 2c is a top view of a mobile printing system 10, and a second mobile printing system 11, shown movably printing a large area image greater than the width of the printer. The second mobile printing system 11 includes a sensor system (not shown in this view) to sense the edges of the first-pass image 40, and features in the previously printed image, to register the to-be-printed second pass image 50 to the first pass image printed by mobile printing system 10.

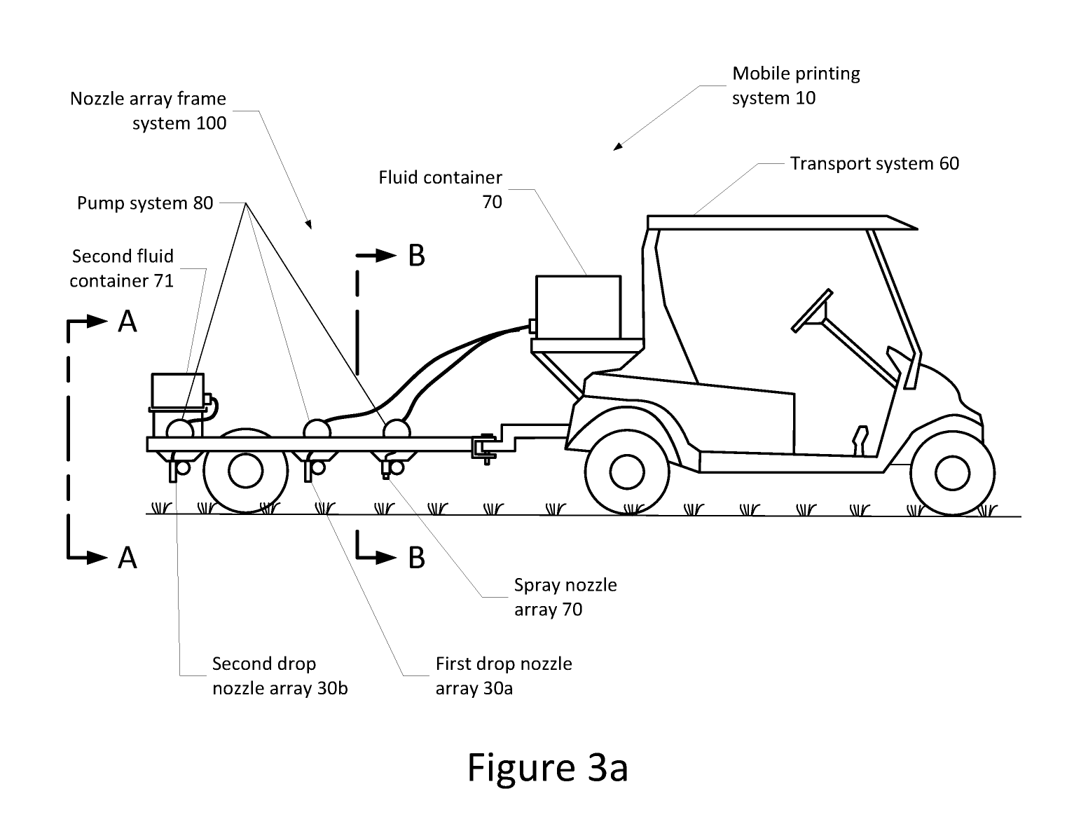

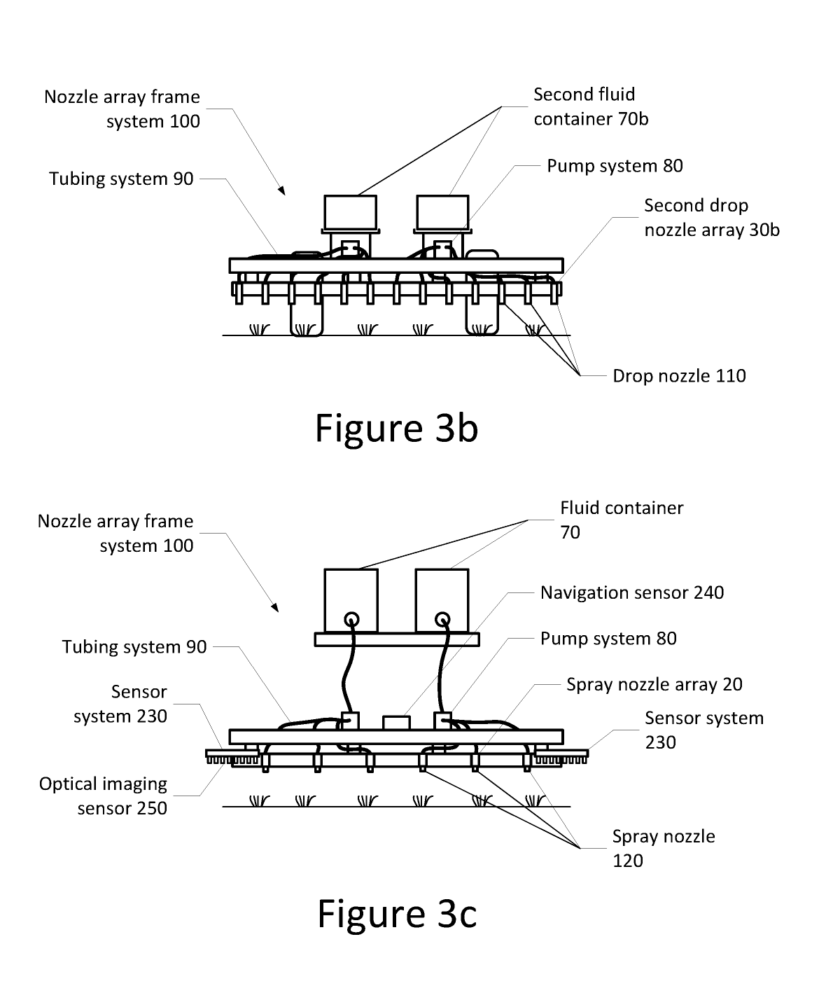

FIG. 3a shows a side view of a transport system 60 and a nozzle array frame system 100, together forming a mobile printing system 10. In this example, the transport system 60 is a golf cart having modifications suitable for the purpose. The transport system 60 may be a tractor, a utility terrain vehicle (UTV), or any other suitable vehicle. The transport system 60 is shown having a fluid container 70 attached. A nozzle array frame system 100 is also shown attached to pull behind the transport system 60. The nozzle array frame system 100 is shown having a spray nozzle array 70, a drop nozzle array 30a, and a second drop nozzle array 30b. Fluid is supplied to each of the nozzle arrays by fluid container 70, and second fluid container 70b. Fluid of the same type and color is shown being supplied to spray nozzle array 70 and drop nozzle array 30a. It may be that a single type and color of fluid is supplied to all nozzle arrays, or that a separate type and color of fluid is supplied to each nozzle array.

For printing large area surfaces such as turf playing fields, the fluid is normally a paint or an ink wherein a carrier generally holds a pigment in suspension (although some agitation may be required to maintain suspension). The carrier may include water or other solvent that is compatible with the application. For printing turf, water is a preferred carrier to avoid damaging the turf. For printing pavement, a wider array of solvents may be used.

Live turf is susceptible to damage by printing or painting fluids having trace metals, an incompatible pH or salinity, or pigments which may block light transmission, thereby having a negative impact on photosynthesis. Preferred fluids for printing live turf are those that are quickly removable and formulated to be relatively harmless to live turf. U.S. Pat. No. 6,653,265 ('265) and U.S. Pat. No. 7,253,140 ('140), incorporated by reference herein in their entirety, each describe a removable paint formulation comprising zinc oxide, water and an adjuvant, and an aqueous removal formulation having a pH of about 4 to 8, comprising an acid and a buffering agent. These patents describe preferred fluids for printing turf according to the present disclosure. Zinc oxide, which is normally white in color, may be replaced by another colorant. A colorant may also be combined with zinc oxide. Colorants may be added to these preferred fluids prior to application (pre-mixed) to any preferred color, including colors that may include trademarked colors such as those owned by sporting teams, businesses, or other organization. Colorants may also be added in-situ, the details of which will follow.

The removal solutions described in '265 and '140, including a formulation having a pH of about 4 to 8, an acid and a buffering agent, are also preferred removal solutions according to the present disclosure. Removing paint may be accomplished by spraying the removal solution onto the surface. It is preferred that the solution be sprayed at a minimum 20 pounds per square inch (psi). Alternately, a brush or broom may be used to provide mechanical assistance to the removal solution.

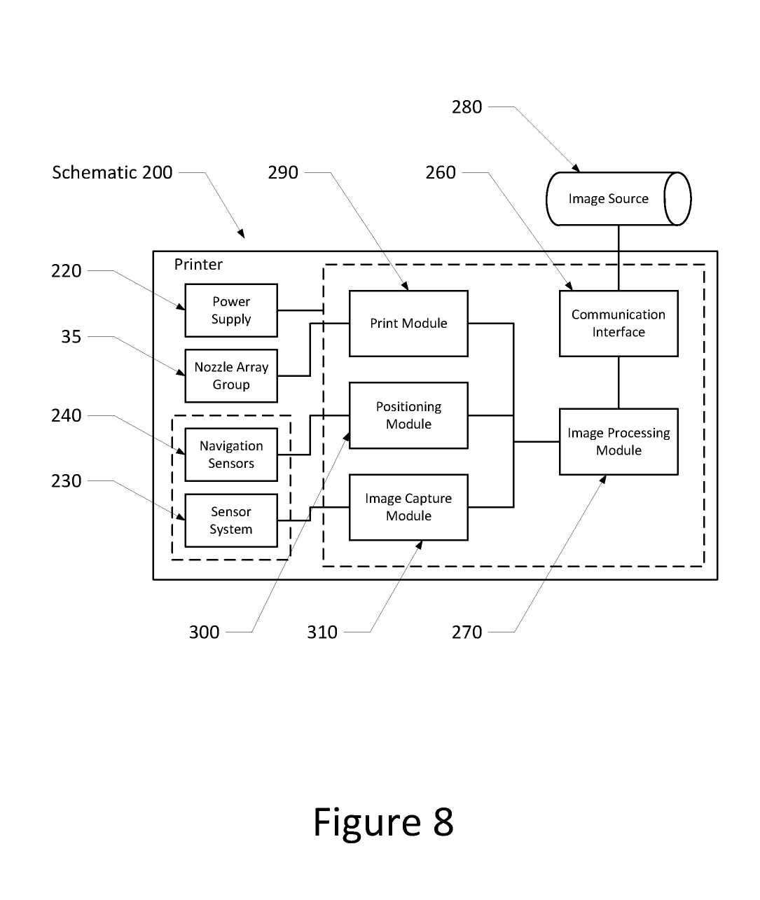

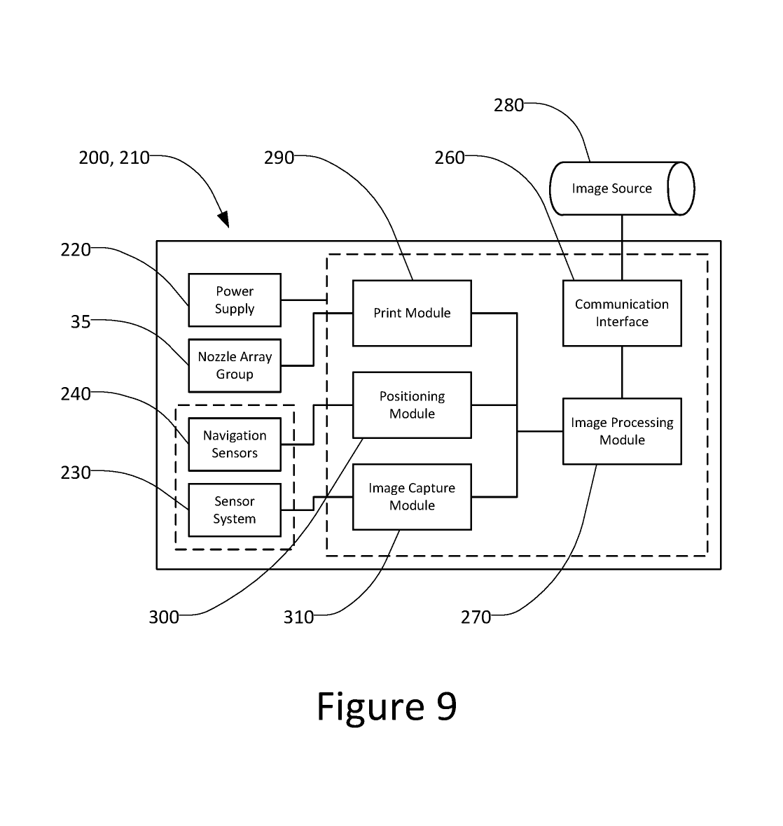

Pump system 80 is shown, one for each nozzle array (30a, 30b, and 70). Fluid is supplied by gravity and by suction from fluid container 70 and second fluid container 71 to three separate pump systems 80. The pump systems 80 may be a peristaltic pump, wherein a positive pressure is created by rollers squeezing a flexible tube which contains the fluid. Alternately, the pump systems 80 may be any other positive displacement pump. The pump system 80 may be electrically coupled to a controller 210 (FIG. 8) to pressurize the nozzle control valve 130 just prior to actuating any of the nozzle control valves 130 in a drop nozzle array 30a or a spray nozzle array 30b. In this way, consistent drop or spray patterns can be maintained while minimizing pressure on the tubing system 90.

FIG. 3b shows a rear view of the nozzle array frame system 100 taken from FIG. 3a, shown from view A-A. From the rear view, the second drop nozzle array 30b is visible. This comprises an array of individual drop nozzles 110. Each drop nozzle 110 is configured to eject a drop (if a drop nozzle 110) or a spray (if a spray nozzle 120) of fluid in response to a control signal corresponding to a digital image and a location. As shown, these are supplied fluid from the second fluid container 70b to the individual drop nozzles 110 via a pump system 80 and tubing system 90. There are many possible variations for supplying fluid to the individual drop nozzles 110.

FIG. 3c shows a view of the spray nozzle array 20 taken from FIG. 3a, shown from view B-B. In the figure, spray nozzle array 20 includes a number of spray nozzles 120. Each spray nozzle 120 is configured to spray a wide pattern of fluid in response to a control signal corresponding to a digital image and a location. As shown, these are supplied fluid from the fluid container 70 (shown as part of transport system 60) via a pump system 80 and tubing system 90. There are many possible variations for supplying fluid to the individual spray nozzles 120.

The mobile printing system 10 may include a mixer 350, controlled by a controller 210 (FIG. 8), to create mixed colors in-situ. In-situ mixing may be used to simplify the fluid delivery of a mobile printing system 10 by requiring only a single base color (such as white), by a single fluid container 70, to be supplied to all nozzle array groups 35. In addition, in-situ mixing may be used to vary the color density of an image area, such as from dark to light.

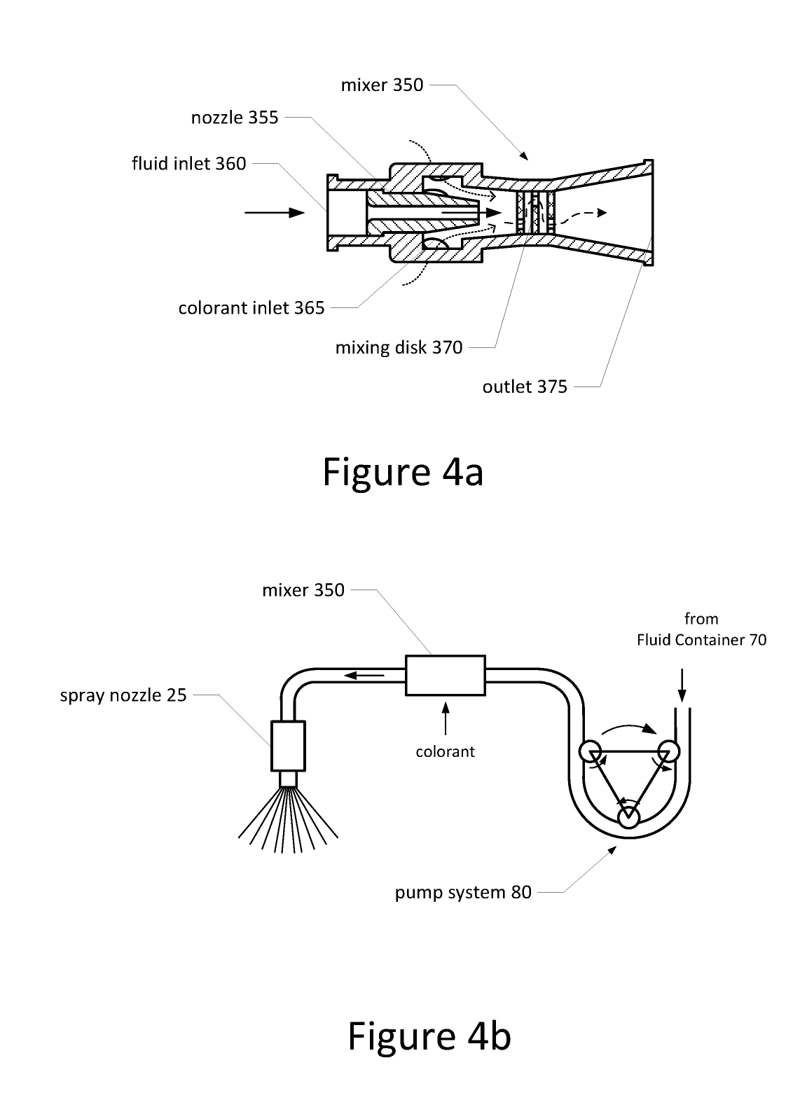

FIG. 4a shows an exemplary mixer 350 used for mixing colorants in-situ. The mixer includes an orifice 355 having a small diameter for increasing the pressure of a base color fluid. One or more colorants are supplied to one or more colorant inlets 365. The base color fluid and one or more colorants flow through a series of mixing disks 370, resulting is the colorants being thoroughly mixed with the base color fluid. The resulting fluid color is ready for use.

When a mixer 350 is used, it is preferred that the mixer 350 be positioned between the pump system 80 and a nozzle (such as drop nozzle 110 or spray nozzle 120) as shown in FIG. 4b. A mixer 350 may be used for each nozzle or for a group of nozzles.

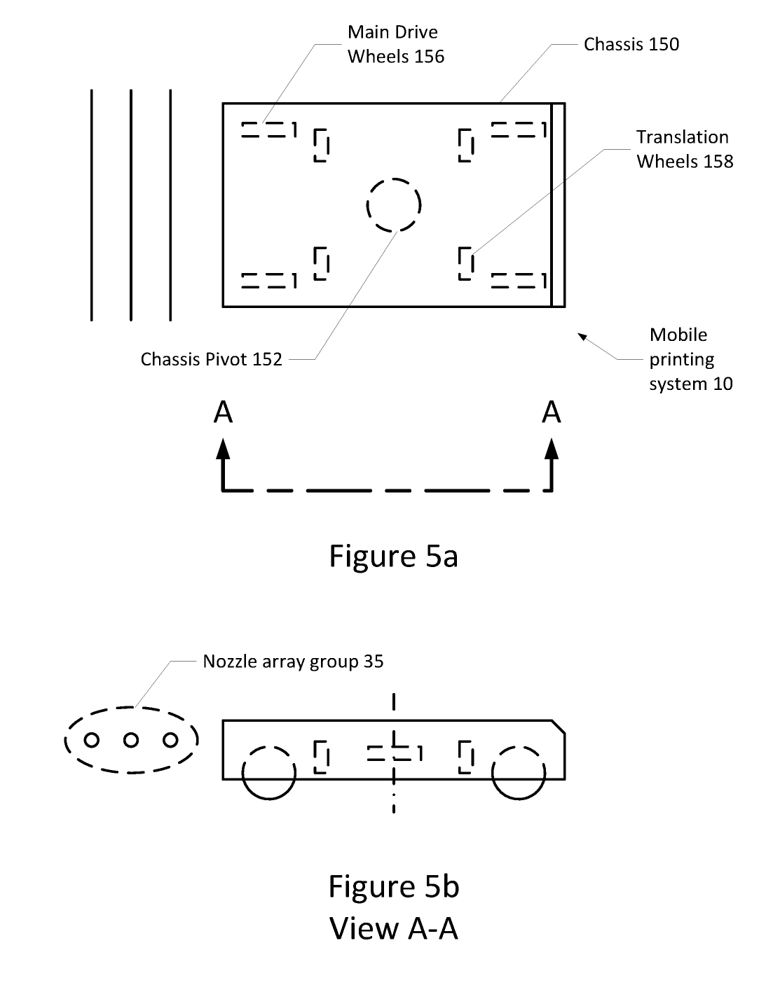

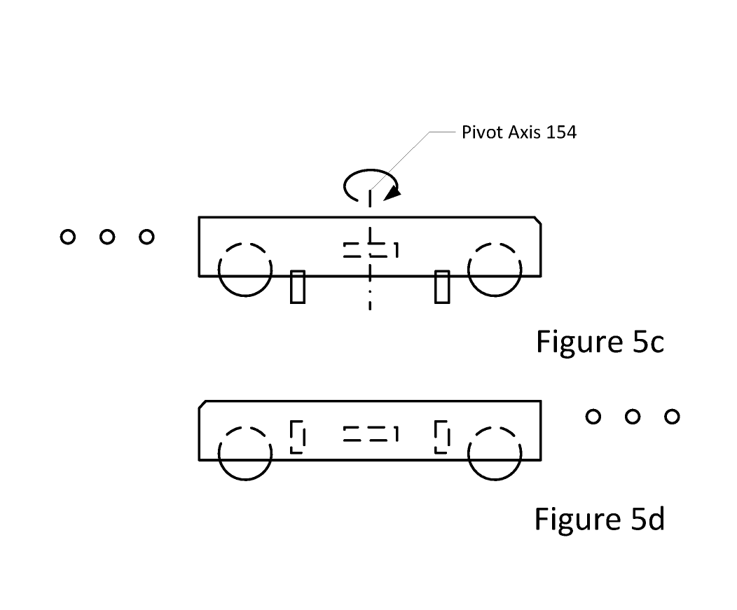

FIG. 5a shows a simplified top view of a mobile printing system 10 having a set of main drive wheels 156 and a set of translation wheels 158. The figure also shows a chassis 150 and a chassis pivot 152, and the nozzle array group 35 on the left side of the chassis 150. FIG. 5b shows a simplified side view of FIG. 5a taken from A-A. In this view, the translation wheels 158 are shown in a retracted position. FIG. 5c shows a side view of FIG. 5a wherein the translation wheels 158 are shown in an extended position. In this position, the mobile printing system 10 is capable of translating at a right angle to the normal direction of travel, thereby reducing the turn-around area required at the end of a paint swath. An extension mechanism (not shown) includes an actuation means for extending or retracting the translation wheels 158 may be, for example, a rotary screw actuator, an electric cylinder, or a hydraulic cylinder. A common mechanism mechanically coupled to the actuation means will complete the extension mechanism.

Also shown in FIG. 5c is an arrow about a pivot axis 154 indicating a 180 degree pivot of the chassis 150 about the pivot axis 152 relative to the frame (not shown). FIG. 5d shows a side view of FIG. 5a wherein the nozzle array group 35 is shown on the right side of the chassis 150 as a result of the chassis 150 having pivoted 180 degrees. In operation, the mobile printing system 10 would now be oriented for printing the next swath by using only a minimal turn area. Alternately, an additional nozzle array group 35 may be added to the opposite end of the mobile printing system 10. This would enable printing in a reverse direction, thereby eliminating the need for a chassis pivot 152.

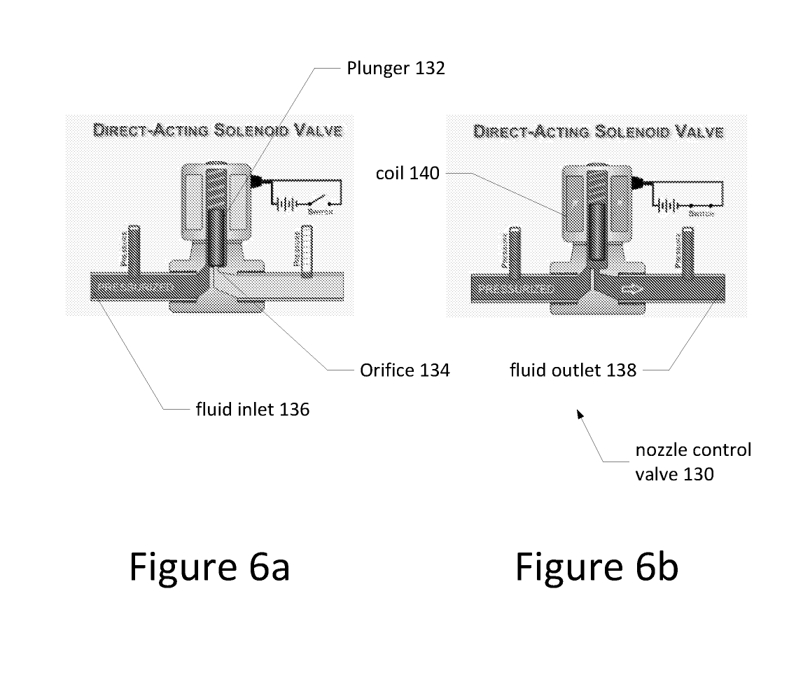

FIG. 6a-b shows an exemplary nozzle control valve 130 in two operational states. The nozzle control valve 130 shown here is a common direct-acting solenoid valve. In operation, pressurized fluid is presented to a fluid inlet 136. Fluid is prevented from passing to a fluid outlet 138 due to a plunger 132 sealing an orifice 134. This is the “normally closed” operational state, which is shown in FIG. 6a. In an “open” state, a coil 140 is energized, causing the plunger 132 to translate axially away from the orifice 134. This opens the fluidic path from the fluid inlet 136 to the fluid outlet 138, as shown in FIG. 6b.

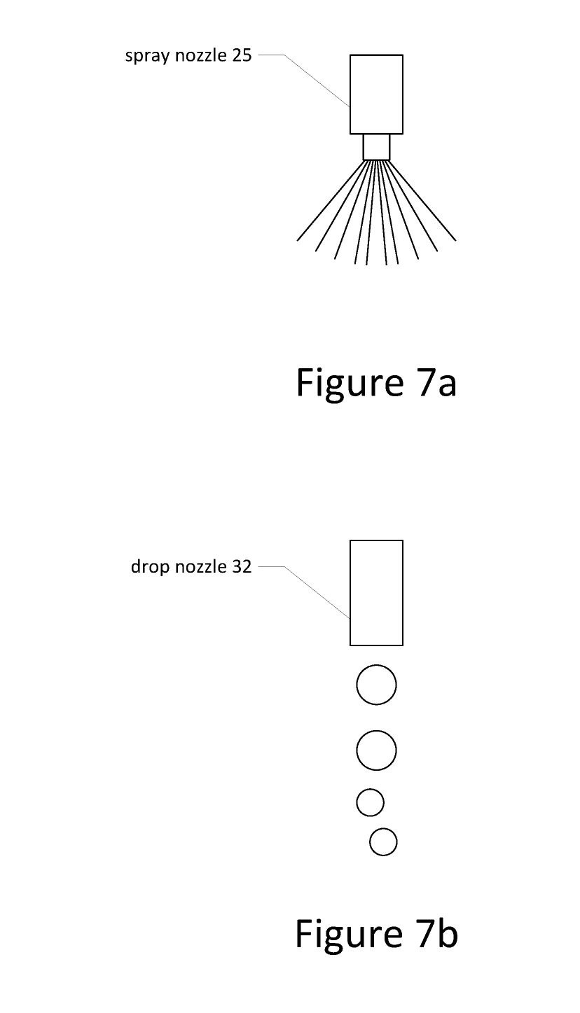

FIG. 7a shows a simplified spray nozzle 25 in operation. As shown, spray nozzle 25 forms a flat fan pattern from the fluid as it is ejected, The fan pattern may be several inches to several feet wide. This is accomplished by many common nozzles currently available. For example, DG TeeJet®, from TeeJet Technologies of Wheaton, Ill., provides a fan pattern but a consistent drop size to reduce drifting of fluids outside the spray zone.

FIG. 7b shows a simplified drop nozzle 32 in operation. As shown, drop nozzle 32 forms a drop pattern of generally well-controlled droplets, causing a narrow drop pattern that ranging from less than one-half inch in diameter to about two inches in diameter. An exemplary drop nozzle 32 is a JELA® nozzle provided by The Lee Company of Westbrook, Conn.

FIG. 8 illustrates a schematic 200 depicting the physical and logical electrical components of mobile printing system 10. The printer may include a controller 210 powered by a power supply 220 and in communication with a nozzle array group 35 and a sensor system 230. The sensor system 230, in this exemplary embodiment, may include one or more position or navigation sensors 240 and one or more optical imaging sensors 250. The controller 210 and the sensor system 230 cooperate to facilitate precise and accurate positioning of the nozzle array group 35 throughout printing operations.

The controller 210 may include a communication interface or module 260 coupled to an image processing module 270 and an image source 280. The image processing module 270 may be communicatively coupled to a print module 290. The print module 290 is communicatively coupled to a positioning module 300.

The image source 280 may be any type of device capable of transmitting data related to an image, picture or file to be printed by the nozzle array group 35. The image source 280 may include a general purpose computing device, e.g., a desktop computing device, a laptop computing device, a mobile computing device, a personal digital assistant, a cellular phone, etc. or it may be a removable storage device, e.g., a flash memory data storage device, designed to store data such as image data. If, for example, the image source 280 is a removable storage device, e.g., a universal serial bus (USB) storage device, the communication interface 260 may include a port, e.g., a USB port, to engage and communicatively receive the storage device. In another embodiment, the communication interface 260 may include a wireless transceiver to allow for the wireless communication of image data between the image source 280 and the controller 210. Alternatively, the communication interface 260 may facilitate creation of an infrared (IR) communication link, a radio-frequency (RF) communication link or any other known or contemplated communication system, method or medium.

The communication interface 260 may, in other alternate embodiments, be configured to communicate with the image source 280 through one or more wired and/or wireless networks. The networks may include, but are not limited to, a personal area network (PAN), a local area network (LAN), a wireless local area network (WLAN), a wide area network (WAN), etc. The networks may be established in accordance with any number of standards and/or specifications such as, for example, IEEE 802.11x (where x indicates a, b, g and n, etc.), 802.16, 802.15.4, Bluetooth, Global System for Mobile Communications (GSM), code-division multiple access (CDMA), Ethernet, etc.

The image processing module 270 may receive the image data from the communication interface 260 and process the received image data to create a print job for use within the printing process. Alternatively, the processing of the image data may be performed by the image source 280 or other device or module and the resulting print job may be communicated to the communication interface 260. The processed image data and/or print job may, in turn, be provided to the print module 290. The print module 290 can cache or store the processed image data or may communicate the data in real-time for printing by the nozzle array group 35.

The positioning module 300 may provide position information to the print module 290. The position information may be utilized to calculate the relative position of the nozzle array group 35 to a reference point 320 defined or established on the surface or within the image data being printed. The position information may be generated or calculated by the positioning module 300 based on signals, measurements or other information received from the one or more navigation sensors 240. The navigation sensors 240 may, for example, be an optoelectronic sensor, an electromechanical sensor or one or more inertial sensors configured to provide location and direction information to the mobile printing system 10 and the nozzle array group 35. The location and directional information may, in turn, be utilized by the positioning module 300 to determine the precise location of the mobile printing system 10 and the nozzle array group 35 relative to the surface upon which the image data is to be reproduced.

The position information provided by the navigation sensors 240 may be utilized by the print module 290, via the positioning module 300, to coordinate the location of the nozzle array group 35 to a position within the processed image data provided by the image processing module 270. The print module 290 may then direct and control the nozzle array group 35 to dispense and deposit fluid on the surface to represent the corresponding portion of the processed image data.

The nozzle array group 35 may be one or more nozzle arrays having a plurality of nozzles configured to dispense a fluid, e.g., liquid droplets, on a surface. The fluid may be contained in fluid container 70 or any reservoir. The fluid container 70 may contain or store paint, ink, or any liquid. Color may include white, black, and/or multiple colors such as cyan, magenta, yellow, and pre-mixed colors. Pre-mixed colors may include trademarked colors such as those owned by sporting teams, businesses, or other organization, as previously described.

The image capture module 310 may receive image information from the one or more optical imaging sensors 250. The optical imaging sensors 250 may be charge coupled devices (CCDs) configured and arranged to capture a plurality of images and/or indicators representative of the surface. The plurality of images may be processed by the image capture module 310 and reassembled to generate a representation of the surface. For example, the optical image sensors 250 may capture, among other things, color data or other indications characteristic or representative of the surface. The image capture module 310 may, in turn, receive positioning information from the positioning module 300 to facilitate the arrangement and reassembly of the plurality of captured images provided by the optical image sensors 250. In this manner, the mobile printing system 10 may be utilized to scan, process, store and duplicate images via the cooperation of the image capture module 310, the positioning module 300 and the print module 290.

The image capture module 310 may, in another embodiment, be utilized to calibrate the positioning module 300. For example, an image captured by the optical image sensors 250 may be compared to the processed image data provided by the image processing module 270 to correct or compensate for accumulated positioning errors and/or to reorient the positioning module 300. For example, if the mobile printing system 10 is removed from the surface during a printing procedure, the positioning module 300 may lose track of the reference point 320 associated with the printing procedure.

The present disclosure will be more readily appreciated with reference to the example which follows.

### EXAMPLE

A mobile printing system 10 comprising a transport system 60 is formed of a golf cart modified for this purpose, and a nozzle array frame system 100 is pulled behind the mobile printing system 10. The transport system 60 includes a nozzle array group 35 consisting of a spray nozzle array 20, a drop nozzle array 30a positioned behind the spray nozzle array 20, and a second drop nozzle array 30b positioned behind drop nozzle array 30a. Each nozzle array has a width of about 6 feet. Optical image sensors 250 are equipped to detect optical reference points 320 in addition to the edge of a previously printed image.

An image in a digital format consisting of a background color and a foreground color is about 15 feet long by about 10 feet wide. (It should be noted that since the nozzle array group 35 is narrower in width than the width of the image, more than one swath will be required to complete the print job.) The image is provided from an image source 280, such as a computer, to a communication interface 260, such as a memory device. An image processing module 270 receives the image from the communication interface 260, which is converted to a print job. The print job includes specific information for addressing the timing and sequencing of nozzles (such as drop nozzle 110 and spray nozzle 120) which, as the nozzles traverse the surface at a given speed and location, form an image on the surface. Reference points 320 are physically positioned on the surface to define an origin for printing the image and are capable of being sensed by optical imaging.

During operation, the mobile printing system 10 approaches the reference points 320. Optical imaging sensors 250 detect a reference point 320, triggering the print job to start while traversing at a predetermined speed. The spray nozzle array 20 sprays a background color. Immediately following the spray nozzle array 20, drop nozzle array 30a dispenses the same background color which defines the edges of the to-be-printed foreground color. Immediately following the drop nozzle array 30a, drop nozzle array 30b dispenses a foreground color. As a result, a partial image of a first print swath is formed which is about six feet wide by about 15 feet in length. The mobile printing system 10 turns to position the nozzle array frame system 100 for the next print swath. Optical imaging sensors 250 detect the edge of the first print swath, which triggers the print job to start again to print a second print swatch, completing the printed image. In this example, the second swath print job is printed in reverse of the first swath print job.

It is contemplated, and will be clear to those skilled in the art that modifications and/or changes may be made to the embodiments of the disclosure. Accordingly, the foregoing description and the accompanying drawings are intended to be illustrative of the example embodiments only and not limiting thereto, in which the true spirit and scope of the present disclosure is determined by reference to the appended claims.

What is claimed is:

1. A mobile printing system capable of movably printing large area images, the printing system comprising:
a. a sensor system;
b. a transport system;
c. a fluid delivery system in fluidic communication with at least one nozzle array;
d. memory for storing digital data that defines a graphical image and a location-based reference; and
e. a processor responsive to the positioning system and generating nozzle control signals responsive to digital data for creating an image.

2. A method of printing a large area image comprising:
a. providing a positioning system for communicating with a printer having a communication range;
b. storing digital data to memory that defines a graphical image and a location-based reference;
c. transporting the printer to within the communication range;
d. identifying at least a reference point and a reference coordinate within the communication range;
e. providing at least one fluid to a fluid delivery system in fluidic communication with at least one nozzle array for dispensing the fluid onto a large area surface;
f. generating nozzle control signals in response to the digital data and the location-based reference;
g. printing the large area image.

3. A controller system for a mobile printing system capable of movably printing large area images, the controller system comprising:
a. an image sensor configured to sense a background color of a surface, and generate background color data corresponding to the sensed background color of the surface; and
b. a controller configured to:
i. receive the background color data;
ii. receive image data corresponding to an image to be printed;
iii. process image color data corresponding to the image data,
iv. compare the background color data with the image color data;
v. determine whether at least some of the background color data; corresponding to the surface and the image color data corresponding to the image data correlate to each other, and;
vi. modify the image data by modifying at least one of a plurality of color layers that comprise the image data when at least some of the background color data corresponding to the surface is determined to correlate with the image color data corresponding to the image data.

4. A mobile printing system comprising:
a. a set of main drive wheels, and;
b. a set of translation wheels, wherein;
i. the translation wheels are capable of retraction to a plane above the main drive wheels, and;
ii. the translation wheels are capable of extending to a plane below the main drive wheels;
c. wherein the set of translation wheels, while extended, are capable of moving the mobile printing system at a right angle to the normal direction of travel.

5. In the figure, a mobile printing system 10 includes three nozzle arrays. A spray nozzle array 20 is shown printing a large area of a solid color (a background color in this instance). This is followed by a drop nozzle array 30a printing the remainder of the background color. A text color is printed by a second drop nozzle array 30b. The sequence of printing in this example ensures, by first printing with spray nozzle array 20, that the text color is not affected by overspray which may occur with the use of spray nozzle arrays.
